(19) United States
(12) Patent Application Publication
(10) Pub. No.: US 2020/0381779 A1
(43) Pub. Date: Dec. 3, 2020

(54) GEL ELECTROLYTE COMPOSITION AND METHOD OF MANUFACTURING GEL ELECTROLYTE USING SAME

(71) Applicants: HYUNDAI MOTOR COMPANY, Seoul (KR); KIA MOTORS CORPORATION, Seoul (KR)

(72) Inventors: Eun Ji KWON, Hwaseong-si (KR); Gwang Seok OH, Seoul (KR); Samuel SEO, Yongin-si (KR)

(73) Assignees: HYUNDAI MOTOR COMPANY, Seoul (KR); KIA MOTORS CORPORATION, Seoul (KR)

(21) Appl. No.: 16/703,155

(22) Filed: Dec. 4, 2019

(30) Foreign Application Priority Data
May 30, 2019 (KR) 10-2019-0063706

(51) Int. Cl. H01M 10/0565

(52) U.S. Cl. CPC H01M 10/0565; H01M 2300/0037

(57) ABSTRACT

Disclosed herein is a gel electrolyte composition and a method of manufacturing a gel electrolyte using the same, and more particularly to a method of manufacturing a gel electrolyte for a lithium-air battery, which is in a gel phase using a gel electrolyte composition including inorganic particles including silica.

### CROSS REFERENCE TO RELATED APPLICATION

This application claims priority to and the benefit of Korean Patent Application No. 10-2019-0063706, filed on May 30, 2019, which is incorporated herein by reference in its entirety.

### FIELD

The present disclosure relates to a gel electrolyte composition and a method of manufacturing a gel electrolyte using the same, and more particularly to a method of manufacturing a gel electrolyte for a lithium-air battery, which is in a gel phase using a gel electrolyte composition including inorganic particles including silica.

### BACKGROUND

The statements in this section merely provide background information related to the present disclosure and may not constitute prior art.

A lithium-air battery uses external air (oxygen) as an active material, and is composed of a cathode having a large specific surface area as an electrochemical reaction site, a lithium-based anode, and an electrolyte. Since oxygen is used as the active material, two kinds of materials, namely air as a gas and an electrolyte as a liquid, which are in different physical phases, cause an electrochemical reaction at a solid cathode to thus generate energy.

Due to the characteristics of the lithium-air battery described above, the cathode that acts as the reaction site of the active material has pores ranging from a macro size to a micro size.

A lithium-air battery is characterized by having an open system that is exposed to external air. In this case, physical volatilization of the liquid electrolyte may occur. Specifically, when the lithium-air battery is driven for a long time, an organic solvent in a liquid phase having a low boiling point is volatilized at the cathode, which receives external air, and thus the electrolyte composition may change and degradation may occur.

Moreover, the liquid electrolyte may be localized due to gravity, and consequently, the localized electrolyte may block cathode pores located in the lower layer.

Conventional devices provide a solid electrolyte including a material having a high molecular weight such as PVdF or PMMA.

However, an organic polymer having a high molecular weight as described above significantly decreases the ionic conductivity with an increase in the amount thereof, and is unstable in oxygen radicals, which are discharge products or intermediate products, resulting in cell degradation.

Therefore, it is desirable to develop a technique making it possible to control the volatilization and flow of the liquid electrolyte while maintaining the basic physical properties of the liquid electrolyte.

The above information disclosed in this Background section is only for enhancement of understanding of the background of the present disclosure, and therefore it may contain information that does not form the prior art that is already known to a person of ordinary skill in the art.

### SUMMARY

In one aspect, the present disclosure provides a lithium-air battery in which volatilization of a liquid electrolyte is reduced or eliminated.

In another form, the present disclosure addresses control the flow of a liquid electrolyte in a lithium-air battery.

In another aspect, the present disclosure provides a gel electrolyte technique that facilitates the design of a lithium-air battery.

In another form, the present disclosure addresses operation of a lithium-air battery.

In another aspect, the present disclosure provides a lithium-air battery having an increased lifespan.

In another aspect, the present disclosure addresses a decrease in ionic conductivity of lithium cations due to the large amount of an organic polymer.

The present disclosure also addresses the impregnability of cathode pores with an electrolyte is lowered due to an increase in viscosity caused by gelation of the electrolyte.

The present disclosure is not limited to the foregoing, and will be able to be clearly understood through the following description.

The present disclosure provides a gel electrolyte composition, which includes: inorganic particles; an initiator; and an organic solvent, in which the inorganic particles include a functional group including a vinyl group on the surface thereof.

The gel electrolyte composition may further include a lithium salt.

The inorganic particles may include silica (SiO₂).

The inorganic particles may include fumed silica (fumed SiO₂).

The inorganic particles may include a functional group of Chemical Formula 1 below.

—R═CH₂ [Chemical Formula 1]

(in which R is a C₁-C₈ hydrocarbon having at least one of linear, branched and cyclic forms.)

The inorganic particles may have a size of 10 to 30 nanometers (nm).

The inorganic particles may have a specific surface area of 125 to 200 m²/g.

The functional group may include any one selected from the group consisting of a methacrylate group, a styrene group, an acrylonitrile group and combinations thereof.

The initiator may includes a UV initiator, a thermal initiator or mixtures thereof.

The initiator may includes 2-hydroxy-2-methylpropiophenone, 2,2-azobis(2-methylpropionitrile) or mixtures thereof.

The organic solvent may include any one selected from the group consisting of tetraethylene glycol dimethyl ether (TEGDME), diethylene glycol diethyl ether (DEGDEE), dimethylacetamide (DMAc) and combinations thereof.

The gel electrolyte composition may include 5 to 20 wt % of the inorganic particles, 0.1 to 1 wt % of the initiator and 79 to 94 wt % of the organic solvent.

In addition, the present disclosure provides a method of manufacturing a gel electrolyte, the method comprising: preparing the gel electrolyte composition described above; and polymerizing the gel electrolyte composition to afford a gel electrolyte.

The polymerizing may be performed by applying any one selected from among UV (ultraviolet rays) and heat.

The polymerizing may be performed for 30 to 60 minutes (min) upon UV polymerization or for 2 to 12 hours (hr) upon heat polymerization.

The gel electrolyte may include a polymer chain including inorganic particles and an organic solvent.

The organic solvent included in the gel electrolyte may be adsorbed to the surface of the polymer chain.

The present disclosure addresses the lithium-air battery field, in which a liquid electrolyte is volatilized.

The present disclosure addresses controlling the flow of a liquid electrolyte in a lithium-air battery field.

The present disclosure provides a gel electrolyte technique that facilitates the design of a lithium-air battery.

The present disclosure addresses degradation that may occur in the cell during the operation of a lithium-air battery.

The present disclosure provides a lithium-air battery having an increased lifespan.

The present disclosure addresses a situation in which the ionic conductivity of lithium cations is lowered due to the large amount of an organic polymer.

The present disclosure addresses the impregnability of cathode pores with an electrolyte, which may be lowered due to an increase in viscosity caused by gelation of the electrolyte.

The present disclosure is not limited to the foregoing, and should be understood to include all effects that can be reasonably deduced from the following description.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a flowchart showing a process of manufacturing a gel electrolyte according to the present disclosure;

FIG. 2 shows the polymer chain including inorganic particles included in the gel electrolyte according to the present disclosure;

FIG. 3 schematically shows a process of loading the gel electrolyte in a gel phase according to the present disclosure to the cathode of a lithium-air battery;

FIG. 4 shows the gel electrolyte composition in a liquid phase prepared in Preparation Example 1;

FIG. 5 shows the results of TEM analysis of the gel electrolyte composition in a liquid phase prepared in Preparation Example 1;

FIG. 6 shows the gel electrolyte in a gel phase obtained in Preparation Example 7;

FIG. 7 shows the results of TEM analysis of the gel electrolyte in a gel phase obtained in Preparation Example 7;

FIG. 8 schematically shows the stacking structure of a lithium-air coin cell of Example 1;

FIG. 9 is a graph showing the results of evaluation of ionic conductivity of Test Example 2;

FIG. 10 is a graph showing the results of evaluation of cell's full capacity of Comparative Example 1;

FIG. 11 is a graph showing the results of evaluation of cell's full capacity of Example 1;

FIG. 12 is a graph showing the results of evaluation of cell's full capacity of Example 2;

FIG. 13 is a graph showing the results of evaluation of cell's full capacity of Example 3;

FIG. 14 is a graph showing the results of evaluation of lifespan at 0.25 mA/cm² in Comparative Example 1;

FIG. 15 is a graph showing the results of evaluation of lifespan at 0.25 mA/cm² in Example 1;

FIG. 16 is a graph showing the results of evaluation of lifespan at 0.5 mA/cm² in Comparative Example 1;

FIG. 17 is a graph showing the results of evaluation of lifespan at 0.5 mA/cm² in Example 1;

FIG. 18 is a graph showing the results of evaluation of high-voltage safety in Example 1 and Comparative Example 1;

FIG. 19 is a graph showing the results of evaluation of the lithium metal electrode stability of the liquid electrolyte in Comparative Example 1; and

FIG. 20 is a graph showing the results of evaluation of the lithium metal electrode stability of the gel electrolyte in Example 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure is not limited to the forms disclosed herein, and may be modified into different forms. These forms are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting the measurements that may occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include any subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

The present disclosure pertains to a gel electrolyte composition and a method of manufacturing a gel electrolyte using the same. According to the present disclosure, the method of manufacturing a gel electrolyte is specified below.

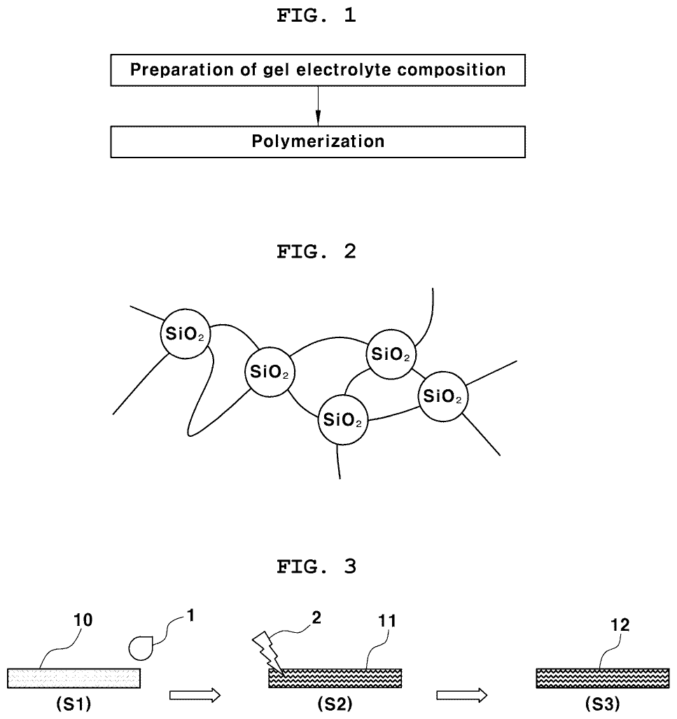

FIG. 1 is a flowchart showing the process of manufacturing a gel electrolyte according to the present disclosure. With reference thereto, individual steps thereof are described below.

### Preparation of Gel Electrolyte Composition

A gel electrolyte composition, which is used for polymerization for obtaining a gel electrolyte according to the present disclosure, is prepared.

The gel electrolyte composition of the present disclosure includes inorganic particles, an initiator, and an organic solvent.

The inorganic particles include a functional group including a vinyl group on the surface thereof. The vinyl group has a double bond in the structure thereof, which may aid in allowing the inorganic particles to polymerize in subsequent procedures.

The inorganic particles include silica (SiO₂). In one form, the inorganic particles include fumed silica (fumed SiO₂).

The inorganic particles have a size of 10 to 100 nm; in some instances, 10 to 30 nm.

The inorganic particles have a specific surface area of 100 to 200 m²/g, or 115 to 200 m²/g, or 125 to 200 m²/g. The specific surface area of the inorganic particles is the main feature that determines whether the inorganic particles may be polymerized to form a polymer chain properly. If the specific surface area of the inorganic particles is less than 100 m²/g, the formation of the functional group on the surface of the inorganic particles may not proceed sufficiently. On the other hand, if the specific surface area of the inorganic particles exceeds 200 m²/g, impregnability of the cathode may decrease due to an increase in the viscosity of the gel electrolyte precursor.

The functional group of the surface of the inorganic particles may be represented by Chemical Formula 1 below.

—R═CH₂ [Chemical Formula 1]

(in which R includes a C₁-C₈ hydrocarbon having at least one of linear, branched and cyclic forms.)

When R of Chemical Formula 1 is a hydrocarbon exceeding C₂₀, the viscosity of the gel electrolyte composition before gelation may be extremely high. In this case, the pores included in the electrode or the separator membrane of a lithium-air battery may not be impregnated properly with the gel electrolyte composition, undesirably lowering the lithium cation conductivity.

The functional group of the present disclosure is appropriate so long as it has a double bond in the chemical structure thereof, like Chemical Formula 1, and may include any one selected from the group consisting of a methacrylate group, a styrene group, an acrylonitrile group and combinations thereof.

In an form of the present disclosure, inorganic particles including a methacrylate group on the surface thereof may be obtained by treating the surface of the inorganic particles with methacryl silane.

The initiator is a substance that absorbs external energy in the polymerization step to thus initiate a polymerization reaction of the gel electrolyte composition.

The external energy may be provided in any form without particular limitation, so long as it breaks the double bond included in the functional group of the surface of the inorganic particles and generates a radical. In the present disclosure, the external energy may be any one of UV (ultraviolet rays) and heat. In one form, the external energy is W. As such, when the external energy is heat, the inorganic particles may undergo a crosslinking reaction due to the heat, but degradation of the organic solvent or the like may occur.

In one form, the initiator includes a UV initiator, a thermal initiator or mixtures thereof.

In another form, the initiator includes 2-hydroxy-2-methylpropiophenone, 2,2-azobis(2-methylpropionitrile) or mixtures thereof.

The organic solvent includes any one selected from the group consisting of tetraethylene glycol dimethyl ether (TEGDME), diethylene glycol diethyl ether (DEGDEE), dimethylacetamide (DMAc) and combinations thereof.

When the organic solvent is tetraethylene glycol dimethyl ether or diethylene glycol diethyl ether, the external energy in the polymerization step may be provided in the form of heat, and when the organic solvent is dimethylacetamide, the external energy may be provided in a UV form.

In the present disclosure, the organic solvent may include dimethylacetamide.

The gel electrolyte composition of the present disclosure may further include a lithium salt depending on the purpose and need thereof. The lithium salt may be included for the purpose of improving the lithium cation conductivity during operation of the lithium-air battery.

The gel electrolyte composition of the present disclosure may include 5 to 20 wt % of the inorganic particles, 0.1 to 1 wt % of the initiator, and 79 to 94 wt % of the organic solvent. Here, if the amount of the inorganic particles is less than 5 wt %, crosslinking may not occur properly. On the other hand, if the amount of the inorganic particles exceeds 20 wt %, dispersion of the inorganic particles in the gel electrolyte composition becomes difficult and the viscosity increases excessively.

The degree of crosslinking of the polymer chain included in the gel electrolyte of the present disclosure may vary depending on the amount of the inorganic particles. Briefly, the degree of crosslinking of the polymer chain may increase with an increase in the amount of the inorganic particles.

### Polymerization

Polymerization is a step in which a double bond included in the functional group of the surface of the inorganic particles generates a radical and polymerization (crosslinking reaction) proceeds. More specifically, while the double bond of the functional group partially breaks and a radical is generated, crosslinking between the inorganic particles proceeds.

When the crosslinking proceeds sufficiently, the inorganic particles are crosslinked to each other, thus forming a polymer chain in a three-dimensional web network form.

FIG. 2 schematically shows the polymer chain included in the gel electrolyte of the present disclosure prepared through sufficient gelation from the gel electrolyte composition. With reference thereto, the polymer chain includes silica (SiO₂), which is inorganic particles, and the polymer chain is in a web network form through crosslinking between the inorganic particles.

As the crosslinking between the inorganic particles proceeds, gelation of the organic solvent of the present disclosure occurs. Here, if the gelation proceeds sufficiently, the gel electrolyte composition becomes a gel electrolyte in a gel phase.

The polymerization is performed by applying any one selected from among UV (ultraviolet rays) and heat, and polymerization may occur while partially breaking the double bond of the functional group using UV (ultraviolet rays) having a wavelength of 380 nm or more. Here, the polymerization is carried out for 30 to 60 min.

Alternatively, when the polymerization is carried out using heat, the polymerization time may be 2 to 12 hr.

The gelation is based on capillary force. More specifically, the polymer chain adsorbs organic solvent molecules based on the capillary force at the surface of the polymer chain, which has a large specific surface area, that is, the surface of the inorganic particles. Thereafter, the polymer chain confines the organic solvent molecules therein so as to maintain a gel phase, and consequently, a gel electrolyte in a gel phase is manufactured from the gel electrolyte composition in a liquid phase according to the present disclosure.

The capillary force of the surface of the inorganic particles causes the organic solvent to bind, thereby significantly reducing the volatility of the electrolyte.

### Method of Manufacturing Lithium-Air Battery

The lithium-air battery of the present disclosure includes a gel electrolyte obtained through the method of manufacturing the gel electrolyte as above.

The lithium-air battery of the present disclosure includes a cathode, an anode, and a separator membrane interposed between the cathode and the anode, and the gel electrolyte of the present disclosure may be loaded to at least one of the cathode and the separator membrane.

The materials for the cathode, the anode and the separator membrane may be used without particular limitation, so long as they are applied to a typical lithium-air battery.

FIG. 3 shows an exemplary form in which the gel electrolyte of the present disclosure is loaded to a cathode. With reference thereto, application of the gel electrolyte in a gel phase according to the present disclosure to the lithium-air battery is described below.

Impregnation with gel electrolyte composition in liquid phase (S1)

A cathode 10 is impregnated with a gel electrolyte composition 1 in a liquid phase.

The cathode 10 is a porous cathode 10 including a carbon material. The pores of the cathode 10 are impregnated with the gel electrolyte composition 1 of the present disclosure.

The impregnation may be carried out at 30 to 100 μl/cm².

### Polymerization (S2)

UV 2 is applied to the cathode 11 impregnated with the gel electrolyte solution so that the gel electrolyte composition 1 incorporated into the pores of the cathode is gelled. Here, the gel electrolyte composition 1 in a liquid phase in the pores of the cathode 11 impregnated with the gel electrolyte solution is gelled into a gel electrolyte in a gel phase.

The process of applying the UV 2 is the same as in the polymerization step of the method of manufacturing the gel electrolyte according to the present disclosure.

Formation of cathode containing gel electrolyte in gel phase loaded thereto (S3)

A cathode 12 containing a gel electrolyte in a gel phase loaded thereto is formed through the initiation with UV 2 in the polymerization step (S2).

The above-described method of manufacturing the cathode containing the gel electrolyte in a gel phase loaded thereto may be equally applied to a separator membrane.

If desired, polymerization may be performed by impregnating the cathode and the separator membrane of the lithium-air battery with the gel electrolyte composition in a liquid phase.

A better understanding of the present disclosure will be given through the following examples, which are merely set forth to illustrate the present disclosure but are not to be construed as limiting the scope of the present disclosure.

### PREPARATION EXAMPLE 1

### Preparation of Gel Electrolyte Composition

7 wt % of inorganic particles (AEROSIL®711), 0.2 wt % of an initiator (2-hydroxy-2-methylpropiophenone) and 92.8 wt % of a dimethylacetamide (DMAc) organic solvent containing 1 M lithium salt LiNO₃ dissolved therein were mixed, thus preparing a gel electrolyte composition.

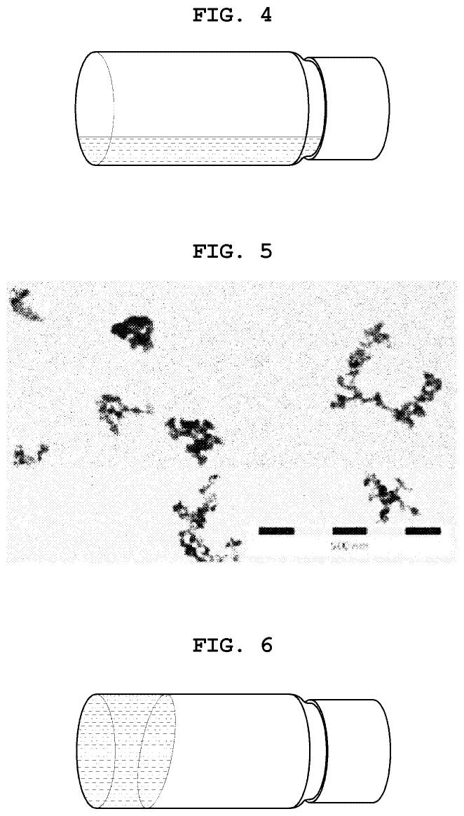

FIG. 4 shows the gel electrolyte composition in a liquid phase prepared in Preparation Example 1. It can be seen that the gel electrolyte composition is affected by the direction of gravity.

FIG. 5 shows the results of TEM analysis of the gel electrolyte composition in a liquid phase prepared in Preparation Example 1. With reference thereto, it can be seen that the inorganic particles are dispersed at a relatively constant interval in the organic solvent.

### PREPARATION EXAMPLE 2

### Preparation of Gel Electrolyte Composition

A gel electrolyte composition was prepared in the same manner as in Preparation Example 1, with the exception that the gel electrolyte composition was composed of 11 wt % of the inorganic particles (AEROSIL®711), 0.2 wt % of the initiator (2-hydroxy-2-methylpropiophenone) and 88.8 wt % of the dimethylacetamide (DMAc) organic solvent containing 1 M lithium salt LINO₃ dissolved therein.

### PREPARATION EXAMPLE 3

### Preparation of Gel Electrolyte Composition

A gel electrolyte composition was prepared in the same manner as in Preparation Example 1, with the exception that the gel electrolyte composition was composed of 5 wt % of the inorganic particles (AEROSIL®711), 0.2 wt % of the initiator (2-hydroxy-2-methylpropiophenone) and 94.8 wt % of the dimethylacetamide (DMAc) organic solvent containing 1 M lithium salt LINO 3 dissolved therein.

### PREPARATION EXAMPLE 4

### Preparation of Gel Electrolyte Composition

A gel electrolyte composition was prepared in the same manner as in Preparation Example 1, with the exception that the gel electrolyte composition was composed of 22 wt % of the inorganic particles (AEROSIL®711), 0.2 wt % of the initiator (2-hydroxy-2-methylpropiophenone) and 77.8 wt % of the dimethylacetamide (DMAc) organic solvent containing 1 M lithium salt LINO 3 dissolved therein.

### PREPARATION EXAMPLE 5

### Preparation of Gel Electrolyte Composition

A gel electrolyte composition was prepared in the same manner as in Preparation Example 1, with the exception that the gel electrolyte composition was composed of 2.4 wt % of the inorganic particles (AEROSIL®711), 0.2 wt % of the initiator (2-hydroxy-2-methylpropiophenone) and 97.4 wt % of the dimethylacetamide (DMAc) organic solvent containing 1 M lithium salt LINO₃ dissolved therein.

### PREPARATION EXAMPLE 6

### Electrolyte Composition in Liquid Phase

A dimethylacetamide (DMAc) organic solvent containing 1 M lithium salt LiNO₃ dissolved therein was prepared.

Preparation Example 7 (Manufacture of gel electrolyte)

Radical polymerization of the gel electrolyte composition in a liquid phase prepared in Preparation Example 1 was performed with UV for 30 min, thus obtaining a gel electrolyte in a gel phase.

FIG. 6 shows the gel electrolyte in a gel phase obtained in Preparation Example 7. With reference thereto, the gel electrolyte in a gel phase attached to the bottom of the bottle can be observed in a semi-solid, non-flowing form.

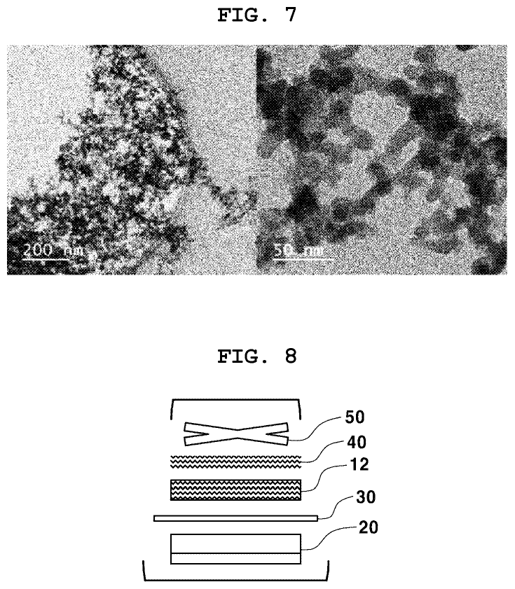

FIG. 7 shows the results of TEM analysis of the gel electrolyte in a gel phase obtained in Preparation Example 7. With reference thereto, it can be seen that the inorganic particles having a size corresponding to ones of nm are connected in a chain shape to form a network, and contain the organic solvent therein to thus maintain a semi-solid gel electrolyte.

### EXAMPLE 1

### Manufacture of Lithium-Air Battery

A gel electrolyte composition was prepared in the same manner as in Preparation Example 1, and was then applied on a CNT electrode (L/L=10 mg/cm²) so that the pores of the CNT electrode were impregnated with the gel electrolyte composition. Here, the gel electrolyte composition was loaded in an amount of 40 μl/cm² to the CNT electrode. The CNT electrode having the gel electrolyte composition loaded thereto was subjected to UV polymerization for 30 min, thus manufacturing a cathode 12 containing a gel electrolyte in a gel phase loaded thereto.

As shown in FIG. 8, the cathode 12 containing the gel electrolyte loaded thereto was interposed between a separator membrane 30 and a gas diffusion layer (Ni-mesh).

An anode 20 including lithium metal was located in the lowermost position, and a spring 50 for fixing the cell was located in the uppermost position, thereby manufacturing a lithium-air coin cell. Here, holes having a diameter of 0.5 mm were formed in the case of the lithium-air coin cell so as to allow external oxygen to flow to the inside thereof.

### EXAMPLE 2

### Manufacture of Lithium-Air Battery

A gel electrolyte composition was prepared in the same manner as in Preparation Example 2, and a lithium-air coin cell was manufactured in the same manner as in Example 1 using the same.

### EXAMPLE 3

### Manufacture of Lithium-Air Battery

A gel electrolyte composition was prepared in the same manner as in Preparation Example 3, and a lithium-air coin cell was manufactured in the same manner as in Example 1 using the same.

### COMPARATIVE EXAMPLE 1

### Manufacture of Lithium-Air Battery

The CNT electrode was impregnated with 40 μl/cm² of the conventional liquid electrolyte of Preparation Example 6, and a lithium-air coin cell was manufactured in the same manner as in Example 1.

### TEST EXAMPLE 1

### Results of Gelation

The results of radical polymerization of the gel electrolyte composition in a liquid phase of each of Preparation Examples 1 to 5 with UV for 30 min are shown in Table 1 below.

TABLE 1

| | Preparation | Preparation | Preparation | Preparation | Preparation |
|---|---|---|---|---|---|
| | Example 1 | Example 2 | Example 3 | Example 4 | Example 5 |
| Amount of | 7 wt % | 11 wt % | 5 wt % | 22 wt % | 2.4 wt % |
| inorganic | | | | | |
| particles | | | | | |
| (degree of | | | | | |
| crosslinking) | | | | | |
| Results | ◯ | ◯ | Δ | ▴ | X |

X = not gelled
Δ = partially gelled
◯ = completely gelled to obtain semi-solid gel electrolyte
▴ = dispersion of inorganic particles impossible and viscosity very high

As is apparent from the above results, the gel electrolyte in a gel phase was obtained through crosslinking in Preparation Examples 1 and 2, and in Preparation Example 3, in which the amount of the inorganic particles was comparatively small, the gel electrolyte in a partial gel phase was obtained.

In contrast, in Preparation Example 4, in which the amount of the inorganic particles was too large, dispersion did not occur properly, and the viscosity of the gel electrolyte composition was excessively high, and in Preparation Example 5, the gel electrolyte in a gel phase was not obtained because crosslinking did not proceed at all.

### Test Example 2

### Evaluation of Ionic Conductivity

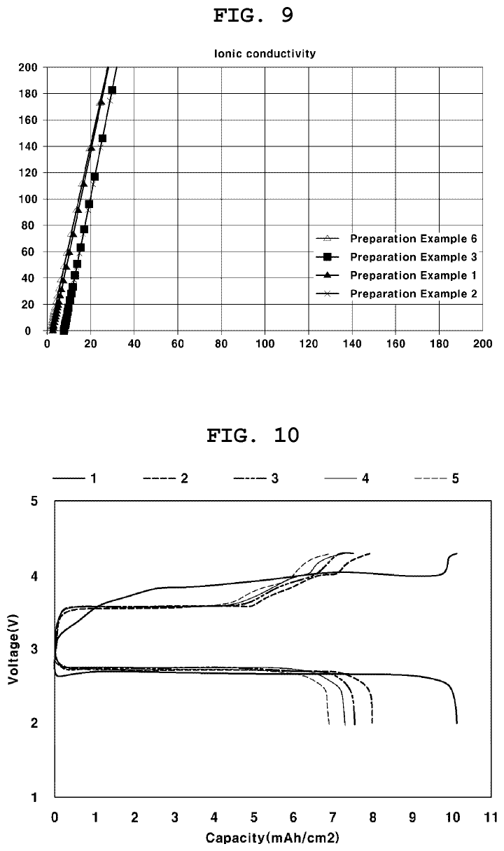

A gel electrolyte in a gel phase was obtained through radical polymerization of the gel electrolyte composition in a liquid phase of each of Preparation Examples 1 to 3 with UV for 30 min, as in Test Example 1. The ionic conductivity of the gel electrolyte thus obtained and the electrolyte composition of Preparation Example 6 was measured. The results are shown in FIG. 9 and Table 2 below.

TABLE 2

| Ionic | Preparation | Preparation | Preparation | Preparation |
|---|---|---|---|---|
| conductivity | Example 1 | Example 2 | Example 3 | Example 6 |
| [mS/cm] | 4.8*10⁻¹ | 1.5*10⁻¹ | 1.7*10⁻¹ | 6.5*10⁻¹ |

As is apparent from the above results, even when the amount of the inorganic particles was increased to 5 to 11 wt %, it can be seen that ionic conductivity similar to that of a liquid electrolyte was obtained.

### TEST EXAMPLE 3

### Evaluation of Cell's Full Capacity

The lithium-air coin cell manufactured in each of Examples 1 to 3 and Comparative Example 1 was evaluated for cell's full capacity. The results are shown in FIGS. 10 to 13.

The measurement was performed at room temperature at a constant current density of 0.5 mA/cm² in the voltage range of 2 V to 4.3 V.

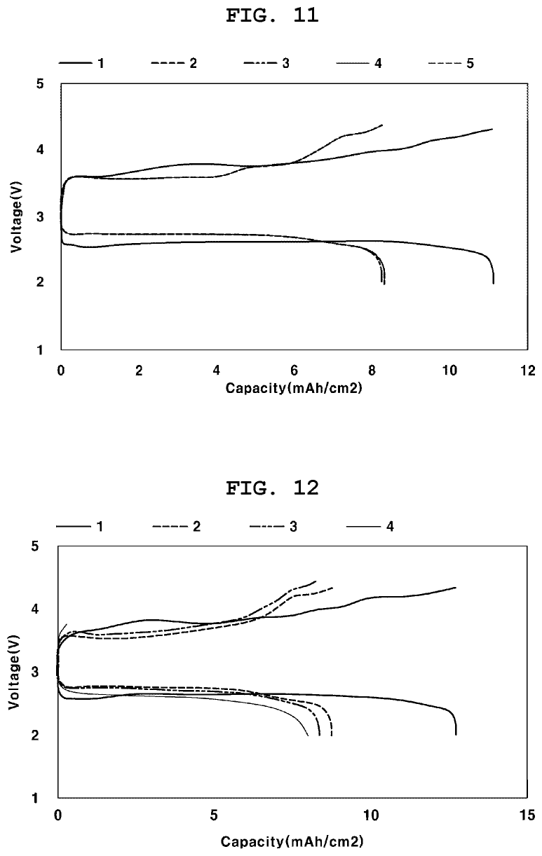

Specifically, FIG. 10 shows the results of Comparative Example 1, FIG. 11 shows the results of Example 1 (7 wt %), FIG. 12 shows the results of Example 2 (11 wt %), and FIG. 13 shows the results of Example 3 (5 wt %).

Referring to the results shown in the drawings, the first discharge capacity of Examples 1 to 3 was 10 to 13 mAh/cm², which can be confirmed to be equivalent to the discharge capacity of Comparative Example 1. In addition, the discharge voltage was about 2.7 V, except for Example 2, indicating that the same voltage as in Comparative Example 1 was maintained.

### TEST EXAMPLE 4

### Evaluation of Lifespan at 0.25 mA/cm²

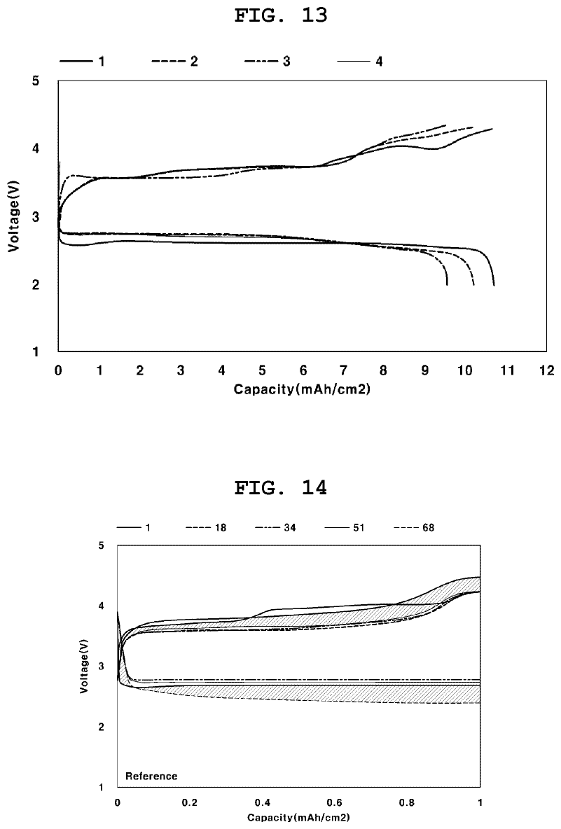

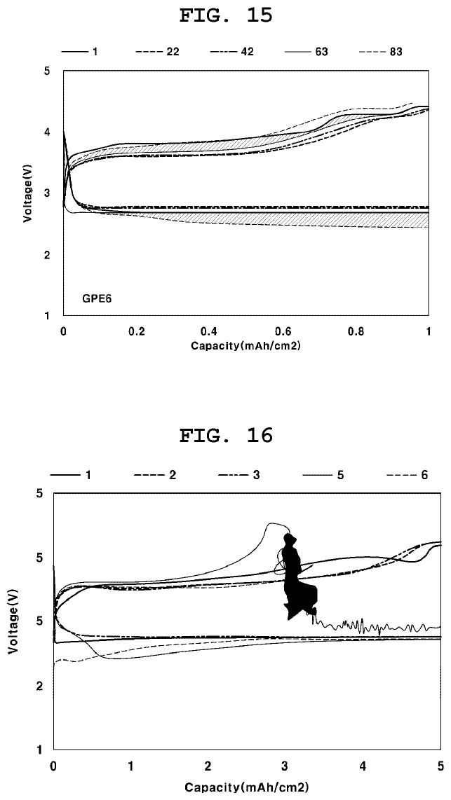

The lithium-air coin cell manufactured in each of Example 1 and Comparative Example 1 was evaluated to determine the lifespan thereof. The results are shown in FIGS. 14 and 15. The evaluation of lifespan was performed at a capacity of 1 mAh/cm² at a current density of 0.25 mA/cm² (FIG. 14 shows the results of Comparative Example 1, and FIG. 15 shows the results of Example 1.)

In Comparative Example 1, the cell was degraded after about 65 cycles, and in Example 1, the cell was degraded after about 80 cycles.

Therefore, the lithium-air coin cell of Example 1 was significantly increased in lifespan compared to the lithium-air coin cell of Comparative Example 1.

### TEST EXAMPLE 5

### Evaluation of Lifespan at 0.5 mA/cm²

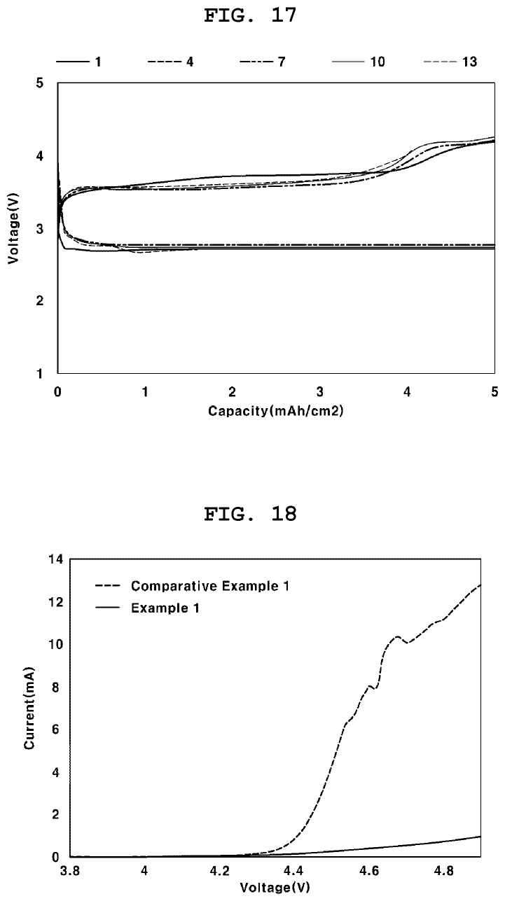

The lithium-air coin cell manufactured in each of Example 1 and Comparative Example 1 was evaluated to determine the lifespan thereof. The results are shown in FIGS. 16 and 17. The evaluation of lifespan was performed at a capacity of 5 mAh/cm ² at a current density of 0.5 mA/cm² (FIG. 16 shows the results of Comparative Example 1, and FIG. 17 shows the results of Example 1.)

In Comparative Example 1, the cell was degraded after about 5 cycles.

In Example 1, the cell was degraded after about 13 cycles.

Therefore, the lithium-air coin cell of Example 1 exhibited a lifespan about 3 times as long as that of the lithium-air coin cell of Comparative Example 1.

### TEST EXAMPLE 6

### Evaluation of High-Voltage Safety

The lithium-air coin cell manufactured in each of Example 1 and Comparative Example 1 was evaluated for high-voltage safety. The results are shown in FIG. 18.

The evaluation was performed through linear sweep voltammetry, and the corresponding current appearing at a constant voltage was observed by changing the voltage from the initial potential (OCV) to 5 V at a scan speed of 0.1 mV/s.

With reference to FIG. 18, when the voltage exceeded 4.4 V, the current value was significantly increased in Comparative Example 1, but in Example 1, a stable current value of 2 mA or less appeared.

### TEST EXAMPLE 7

### Evaluation of Stability

In order to confirm the lithium (Li) metal electrode stability of the electrolytes used in Example 1 and Comparative Example 1, a lithium metal symmetric cell was manufactured and evaluated.

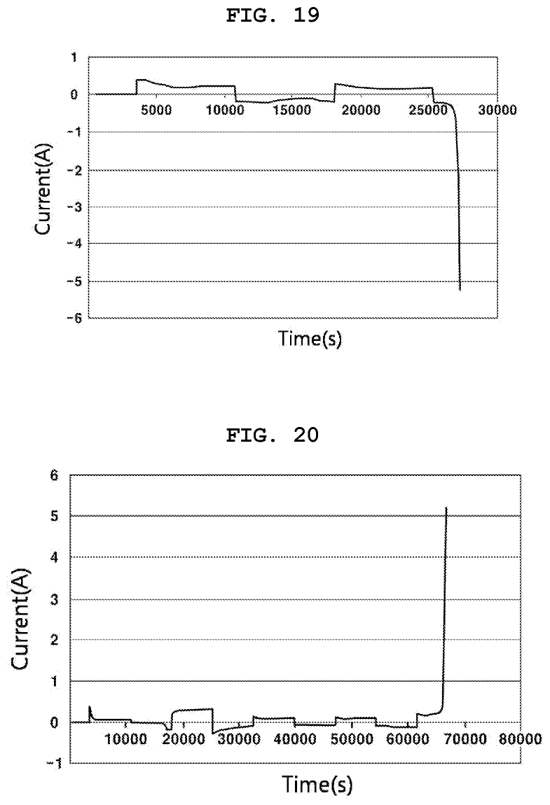

With reference to FIG. 19, in the lithium symmetric cell manufactured with the liquid electrolyte of Comparative Example 1, the constant current applied to the lithium metal was not maintained at the 2^{nd} cycle after the 1^{st} cycle of lithium metal stripping/plating, and thus, overcurrent flowed due to the side reaction of the lithium metal and the electrolyte, and the lifespan thereof ended. In contrast, in the case of the lithium symmetric cell manufactured with the gel electrolyte of Example 1 in FIG. 20, it was confirmed that the cycle lifespan was sustained by virtue of the greatly improved stability thereof.

Although forms of the present disclosure have been disclosed for illustrative purposes, those skilled in the art will appreciate that various modifications are possible without departing from the scope and spirit of the disclosure.

While this present disclosure has been described in connection with what is presently considered to be practical exemplary forms, it is to be understood that the present disclosure is not limited to the disclosed forms, but, on the contrary, it is intended to cover various modification and equivalent arrangements included within the spirt and cope of the present disclosure.

What is claimed is:

1. A gel electrolyte composition, comprising:
inorganic particles;
an initiator; and
at least one organic solvent,
wherein the inorganic particles include at least one functional group including a vinyl group on a surface thereof.

2. The gel electrolyte composition of claim 1, further comprising a lithium salt.

3. The gel electrolyte composition of claim 1, wherein the inorganic particles include silica (SiO₂).

4. The gel electrolyte composition of claim 1, wherein the inorganic particles include fumed silica (fumed SiO₂).

5. The gel electrolyte composition of claim 1, wherein the inorganic particles include a functional group of Chemical Formula 1:
—R═CH₂ [Chemical Formula 1]
wherein R is a C₁-C₈ hydrocarbon having at least one of linear, branched and cyclic forms.

6. The gel electrolyte composition of claim 1, wherein the inorganic particles have a size of 10 nm to 30 nm.

7. The gel electrolyte composition of claim 1, wherein the inorganic particles have a specific surface area of 125 m²/g to 200 m²/g.

8. The gel electrolyte composition of claim 1, wherein the functional group includes at least one of a methacrylate group, a styrene group, an acrylonitrile group and mixtures thereof.

9. The gel electrolyte composition of claim 1, wherein the initiator includes a UV initiator, a thermal initiator or mixtures thereof.

10. The gel electrolyte composition of claim 1, wherein the initiator includes 2-hydroxy-2-methylpropiophenone, 2,2-azobis(2-methylpropionitrile) or mixtures thereof.

11. The gel electrolyte composition of claim 1, wherein the organic solvent includes at least one of tetraethylene glycol dimethyl ether (TEGDME), diethylene glycol diethyl ether (DEGDEE), dimethylacetamide (DMAc) and mixtures thereof.

12. The gel electrolyte composition of claim 1, wherein the gel electrolyte composition comprises:
5 to 20% of the inorganic particles by weight,
0.1 to 1% of the initiator by weight, and
79 to 94% of the organic solvent by weight.

13. A method of manufacturing a gel electrolyte, the method comprising:
preparing a gel electrolyte composition including inorganic particles, an initiator, and an organic solvent; and
polymerizing the gel electrolyte composition to afford a gel electrolyte.

14. The method of claim 13, wherein the polymerizing is performed by applying any one selected from among UV (ultraviolet rays) and heat.

15. The method of claim 14, wherein the polymerizing is performed for 30 minutes to 60 minutes upon UV polymerization.

16. The method of claim 14, wherein the polymerizing is performed for 2 hours to 12 hours upon heat polymerization.

17. The method of claim 13, wherein the gel electrolyte includes a polymer chain including inorganic particles and an organic solvent.

18. The method of claim 17, wherein the organic solvent included in the gel electrolyte is adsorbed to a surface of the polymer chain.
